(19) United States
(12) Patent Application Publication
(10) Pub. No.: US 2010/0312628 A1
(43) Pub. Date: Dec. 9, 2010

(54) SYSTEM AND METHOD FOR DELIVERING CONTENT BASED ON AN EVALUATION OF SENSITIVITY TO SOCIAL ISSUES

(76) Inventor: Graham Reid, Oakville (CA)

Correspondence Address: Adams and Reese LLP, 1221 McKinney Street, Suite 4400, Houston, TX, 77010, US

(21) Appl. No.: 12/795,311

(22) Filed: Jun. 7, 2010

Related U.S. Application Data
(60) Provisional application No. 61/185,140, filed on Jun. 8, 2009.

(30) Foreign Application Priority Data
Jun. 26, 2009 (CA) 2670668

(51) Int. Cl. G06Q 99/00; G06Q 50/00; G06Q 30/00; G06Q 10/00; G06F 15/16; G06Q 40/00

(52) U.S. Cl. 705/14.19; 705/14.52; 705/321; 709/204; 709/206

(57) ABSTRACT

The invention is directed to a method and system for delivering content to users over a computerized system based on an evaluation of sensitivity to social issues, by collecting information from a user and preferably at least one other individual that knows the user regarding the user's sensitivity to a social issue, evaluating the user's sensitivity to the social issue on the basis of information gathered, and selecting issue-specific content to be displayed to the user that is selected from a pool of content by the system based on its relevance to the user's sensitivity to the social issue.

### CROSS REFERENCE TO RELATED APPLICATIONS

This application claims the benefit of U.S. Provisional Patent Application No. 61/185,140, filed on Jun. 8, 2009, and further claims priority to Canadian application number 2,670,668 filed on Jun. 26, 2009.

### FIELD OF THE INVENTION

The present invention relates to an online networking system that directs content to users.

### BACKGROUND OF THE INVENTION

Social networking relates to services and tools that help users maintain and expand relationships. The Internet has witnessed significant development in the realm of social networking and online marketing. For example, social networking sites such as Facebook have expanded from a simple university-based network into a worldwide social network with customized marketing tools that tailor ads to a user based on age, gender and geographical location of the user.

However, social networks do not typically consider the sensitivity of any particular user to social issues or needs. Social issues are problems or moral controversies that affect some or all of the members of a community. Social issues depend largely on the needs of the particular community in which they arise, and can vary widely depending on social, political, economic and cultural pressures that shape that community. Social issues include discrimination in all forms, violence, poverty, pollution, abuse, negative self image and esteem, and health issues. There is a grave need to reach members of the community, such as adolescents, that are experiencing gangs, violence, high dropout rates, teen pregnancies, drugs, and other social issues. Reaching these at-risk youth early, in ways that will effectively and consistently engage them, improves the chances that the adolescents will address these issues successfully.

Providing resources to address an individual's social need has typically been done through social and community (or youth) programs in person, or through mass media, including posters, static billboards, TV-based Public Service Announcements (“PSAs”) and various forms of print collateral. The problem with direct person to person interaction is that it is comparatively expensive to assess the needs of every individual in a community and provide them with resources that are customized to fit their needs. Mass media advertising does not address the specific needs of any individual, as it is prepared for a wide audience.

There is a significant need for youth-oriented and school-integrated solutions that incorporate mobile technology (e.g. SMS-text) and/or internet technology to deliver content, such as resources, and job and volunteer opportunities based on a user's sensitivity to social issues.

### SUMMARY OF THE INVENTION

The invention is directed to a method for delivering content to users over a computerized system based on an evaluation of sensitivity to social issues, comprising:

(a) collecting information from a user, the information including at least one primary data point that indicates the user's sensitivity to at least one social issue;
(b) evaluating the user's sensitivity to the at least one social issue on the basis of the at least one primary data point;
(c) selecting issue-specific content to be displayed to the user that is selected from a pool of content by the system based on its relevance to the user's sensitivity to the at least one social issue.

The invention further comprises collecting information about a user from at least one other individual that knows the user, the information including at least one secondary data point that indicates the user's sensitivity to the at least one social issue; and evaluating the user's sensitivity to the at least one social issue on the basis of the at least one primary data point and the at least one secondary data point.

### BRIEF DESCRIPTION OF THE FIGURES

Embodiments of the invention will be described by way of example and with reference to the drawings in which:

FIG. 1 is a schematic view of an embodiment of a system performing the method according to the invention.

### DETAILED DESCRIPTION

### Gathering Information

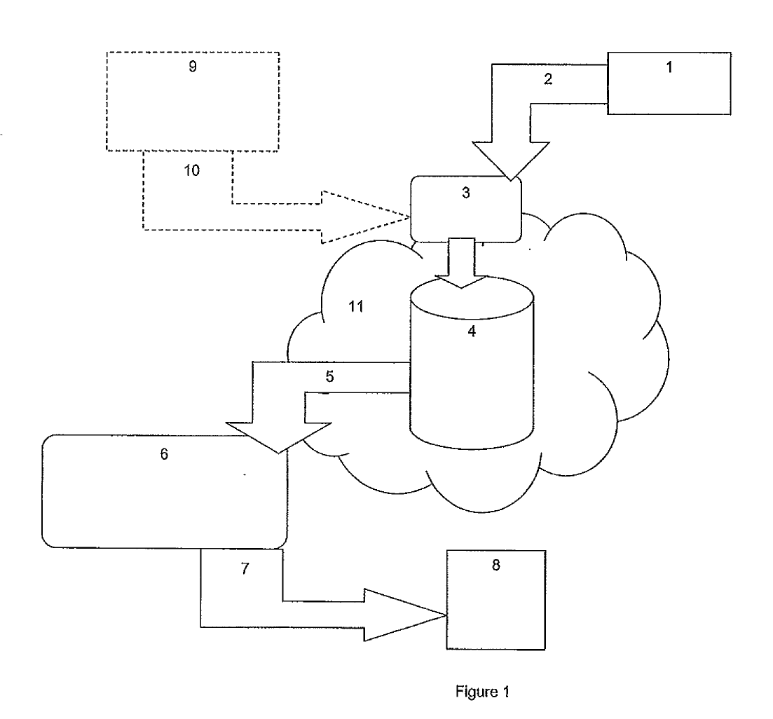

As shown in FIG. 1, the system for evaluating a user's sensitivity to social issues collects information 2 from a user 1, the information including at least one data point 3 that indicates the user's sensitivity to at least one social issue. In one embodiment, the system conducts a survey of the user regarding at least one social issue, posing a number of questions designed to evaluate the user's sensitivity in that regard. Specifically, each index has a set of queries and other criteria that a user must complete that pertain to at least one social issue. Once the user has completed answering queries, the system 11 generates 4 a score or statement 5 representing the user's sensitivity to that social issue.

In one embodiment, a third party 9 (such as a parent, teacher, guardian or an individual authorized by the user) who knows and is known to the user, may be queried by the system 11 to collect a second set of data 10 regarding the user's sensitivity to the social issue. Using the collected data, the system's software may generate 4 a revised score or statement 5 based on both the user's data and the third party's data. The system may gather information from more than one third party source.

The responses to surveys via the system may be either in numerical form such as responding with a number between 0 and 10 to reflect the degree of agreement or disagreement with a given survey question. Other questions may, for example, be in the form of “Yes”, “No”, “Maybe”, “Don't Know” and then preferably assigned a numerical value or statement afterwards. Once an answer is given and depending on the type of answer, the system's software will map the answer according to numerical values to generate the score or statement.

The system may gather other information from the user that may or may not necessarily be used in completing the indices and generating the scores or statements. This extraneous information is gathered through the system's software running on a programmable machine and is stored on the system's hard drive or other programmable media. The extraneous information may be used to provide a social networking connection between users of the system or any other means of developing relationships with other users. For example, the system may also collect other information specific to the user, such as user's availability for employment, age, resume and geographical location. In an educational setting, performance in an educational environment may be collected using an academic record, and truancy may be evaluated using attendance records.

In one embodiment, the invention may be used in conjunction with other software, networks or online websites that provide additional information about the user, such as another user's social networking profile found on other websites, or a school network's profile of the user. The system may harvest data found on those other sites, with the user's permission, to create a more comprehensive profile of the user.

### Evaluating Need

Once the queries are completed by all required parties, the system 11 uses an algorithm to process the completed queries and other completed criteria to generate a user score or statement 5 for each social issue as part of their profile.

The selection of content for delivery may be based upon the score or statement satisfying criteria associated with each piece of content. These criteria may be benchmarks or thresholds against which the score or statement is compared to determine whether the content is relevant to the user. The criteria may be a range such that when the score or statement falls within the range, the content is deemed to be relevant.

In one embodiment, the score or statement 5 generated based on user and third party data points 2, 10 are evaluated 6 against benchmarks or thresholds that are programmed or predetermined within the system. Once a benchmark or threshold is surpassed for a particular issue, content 7 will be assigned 8 to the particular user relating to the particular issue. Weighted averages of the data points from multiple sources may be used to assist in assessing a user's sensitivity to a particular social issue, based on who the third party is and what their relationship is to the user. In some instances, it may be appropriate to assign weighting for third party input based on the social need. For example, in assessing whether an individual is at risk of committing a crime, the user's psychologist, parole officer, or criminal record may be assigned a comparatively higher weighting as a third party source because their contents are more likely to be objectively relevant to assessing that particular social need.

For example, the user may have answered ten questions regarding their sensitivity to bullying. Each question is assigned a value by the system in a range from 0 to 10, which comprises the data. The data is aggregated or averaged to produce a score. In this example, the score may be 7, indicating an elevated sensitivity to this social issue. The system may then flag content that addresses bullying to be delivered to the user.

In a preferred embodiment, content 7 is delivered 8 when it falls within, below, or outside of a pair of benchmarks, in addition to being delivered above a benchmark. The ranges of scores or statements at which content is delivered is dependent on the content's relevance to the social need, and the likelihood that the user will be receptive to that particular content. Users are more likely to be receptive to certain types of messages regarding social needs depending on their sensitivity. If the user is overly sensitive to a social issue, the message may be ignored, or may be received with hostility, anger or resentment, undermining the effectiveness of delivering the message. If the user is not particularly sensitive to a social issue, the content is irrelevant to them, and the effort of directing it to them is wasted.

The system 11 will compare 6 each user profile and score or statement 5 against benchmarks to classify the user under certain social needs areas such as violence, participation in gangs, oppression, bullying, obesity and other health risks, substance abuse, theft, street racing, suicide, divorce or separation of parents or guardians, domestic abuse, truancy, discrimination on the basis of race, creed, skin colour, ethnicity, sexual orientation, gender, age, disability/ability, religion, or heritage, sexual activity, abstinence, teen pregnancy, sexually transmitted infections, sexual assault, and abortion. There may be more than one user profile and index depending on the user's social needs and a user profile or index may be assigned under one or many social needs areas by the system.

### Delivering Content

Once the user's sensitivity to particular social needs has been assessed 4, and a score or statement 5 has been generated, the system 11 will deliver 8 content 7 for each user that may be displayed through a website on the Internet on the basis of the score or statement. The content may consist of a diverse and extensive menu of advertisements, programs or other opportunities including community programs relating to certain social needs, charities, mentoring, volunteer and job opportunities. The advertisements or content may contain contact information or links to resources that pertain to a particular social need. Such advertisements may last approximately 15-30 seconds each and may also be broadcast daily via strategically placed digital signage i.e. digital screens or displays.

Content may be reviewed in advance to assign criteria to each piece of content, to determine the relevance of each piece to each social issue, and determine under what circumstances each piece will be displayed to users of the system.

Content may be relevant to more than one social issue, and therefore may have more than one criterion associated with it. The system may review the criteria associated with all content, and generate a report representing the coverage of social issues that the system can currently address. This may allow system administrators to identify social issues or levels of user sensitivity that require more coverage, to allow the system to better deliver a range of relevant content to the users.

In a preferred embodiment, the system may run advertisements on most if not all profile pages and portals and may be mandatory for users when they first login to their profile or view other web-pages. Users may have an opportunity to support their school, a major charity partner, or any cause of their own choice, by simply watching advertisements.

In a preferred embodiment, the digital signage system may be designed to work in conjunction with a website which can serve as a central online hub through which users can manage a profile with updated personal information including their resume. The system may feature job and volunteer feeds based on a user's selected criteria and generic feeds of the same over the digital signage screens. Images or videos that pertain to social issues may be used. Users may respond to job or volunteer opportunities that are posted as a general or custom feed at regular intervals on the digital signage screens (displays), the website and/or their cell phones.

In one embodiment, users may have their profile information (e.g. contact details) and/or resume (stored within their profile on the system) sent to the prospective employers, non-profit organisations, social service organisations, community centres or volunteer agencies with which they would like to connect. The user may instruct the system's messaging module via mobile technology (e.g. SMS) to send this information in response to incoming content or offer containing the prospective employment or volunteer position or after-school activity. Users may find information in other areas such as recreation, entertainment, after school programs, sports, tutoring, mentoring, compatibility matches (matching service to generate new friends); as well as get free or paid ringtones in future phases of the site. The system will also allow clients (e.g. high school staff/administration) to periodically post bits of information for their staff or student body e.g. after-work or after-school activities, volunteer opportunities, school bulletins, which may go out on the displays as well as the feeds generated by the system's software for the system's web-pages or portals.

In one embodiment, the system could be divided into at least two groups: Clients (e.g. youth, students etc.) and Facilitators (e.g. organizations, employers, advertisers, sponsors, causes, mentors, parents and teachers). Each group may setup and maintain a profile on the site and will be able to share and exchange information and documents within the site or via mobile communication (e.g. SMS).

When a user has their settings configured to receive data through mobile communication such as SMS, users may use their mobile phone to initiate the system's “SEND” function in order to reply to a particular opportunity or offer, with their contact details or resume for example. The system may have the ability to populate headers and content of a default reply by grabbing details from the original opportunity or offer and reuse those details to auto-populate the reply letter with the respective salutations. The system may use a simple code that allows the user to designate which resume or content, for example, they want to respond with. The reply content may not need to be sent as an attached document but may be automatically set up as pre-formatted content that is embedded within a special form that is a part of the system. All reply data may be located within the system's database. Notifications on the site may also come via their custom feeds which are configured based on the user index and profile.

In another embodiment, teachers or other people in positions of authority may use the system to post information, such as academic marks and attendance scores, about the user that may or may not be publicly available. This information could promote the user or adversely affect the user. The system's software will create certain rights available to certain users which may or may not restrict abilities to post items on certain areas of the user's profile. The system's software may also be designed to use academic marks and attendance scores posted by teachers or other authoritative figures to financially benefit the user, determine most appropriate advertisements (and associated programs, networks, services) and automatically channel them towards that user's ad programming menu.

In one embodiment, the system may be complemented by a display (digital signage screen or monitor) to be mounted in schools, general organizations and offices. Each screen may deliver messages that are customized specific to the environment or building, and may be based on the “typical” or average user that is likely to view the content in that space. If a user is a school or other organization, messages may be custom-created campaigns which may be pre-selected by the client from a menu of available options.

### The System

A system implemented in accordance with the present invention may comprise a computer system having memory and a processor to execute the code. The system may also comprise a server and client structure, where the user is instructing the system via a client terminal, including a wireless handheld device or cell phone, and the method is performed on a server.

The software may include executable code stored in a memory for execution by a processor. A memory may include any static, transient or dynamic memory or storage medium, including without limitation read-only memory (ROM) or programmable ROM, random access registers memory (RAM), transient storage in registers or electrical, magnetic, quantum, optical or electronic storage media, but excludes a signal in transmission. A process includes any device or set of devices, howsoever embodied, whether distributed or operating in a single location, that is designed to or has the effect of carrying out a set of instructions, but excludes an individual or person.

A display is any device capable of displaying video content to an individual, such as an LCD, LED, plasma screen, projector, CRT, or other type of video screening equipment.

It will be appreciated that the above description relates to the preferred embodiments by way of example only. Many variations on the method and system for delivering the invention without departing from the spirit of same will be clear to those knowledgeable in the field, and such variations are within the scope of the invention as described and claimed, whether or not expressly described. For example, the system is not limited to use by children, adolescents, or young adults in an educational environment. The system may also be used in corporate environments and other settings where addressing social issues is a pressing concern.

### Additional Features

In one embodiment, the system's software may assess intersecting degrees of compatibility reflected on a numerical scale that instantly tells the user via a score (or graphic representation) next to someone's profile picture how compatible they are. Users can enable or disable this feature. This feature may be a fee-based service for a dating application or business application. This feature may show the user their score next to another user's picture to indicate the index of compatibility i.e. based on the criteria that the user has pre-selected and designated as desirable in his or her profile preferences. This may be limited to university or college students or other individuals that have reached the age of majority. The system may calculate the degree of compatibility between criteria that the user has pre-selected and designated as desirable in his or her profile preferences, and another user's information, and display to the user the degree of compatibility. The system may also calculate a compatibility score by comparing the degrees of compatibility of two users with each other. If both degrees of compatibility are high, the compatibility score will be high, to represent that each user is a potentially good match for the other.

In another embodiment, sponsor organizations (e.g. non-profits, social service providers etc.) may be automatically placed and tagged in or around advertisement spots catering to users that are within a certain proximity (radius) of their physical business location. Sponsors may be able to adjust proximity settings and can add or include additional jurisdictions (outside of their default region). Prospective sponsor organizations may see their location with a concentric circle around it representing the range of coverage and exposure to users that live within the defined circular boundaries. The circle may be moved around their point of location to adjust the specific surrounding areas to be included within the boundary. As prospective sponsors move the circle around their location on the map, there may be a dynamic counter indicating the amount of users (delineated by age, gender etc., for example) that live, attend school or work within the defined area, enabling sponsors to dynamically position their “proximity circle” to reach the maximum or optimal amount of system users that are located within the surrounding area of their location. The sponsor may also choose to increase the frequency of their content within the proximity circle, or widen the radius of their proximity circle.

In another embodiment, users may accumulate credits that may be used to fund charitable donations by watching the advertisements every time they sign in. Users may also accumulate their own personal credits e.g. 1 (one) credit per $10 accumulated donation. These credits may be redeemed via online shopping (e.g. for video games, clothing, music, books etc. from participating online shopping partners) through PayPal or other online banking account. Credits will be specially coded to be only valid for the user they belong to. The rate of accumulation may change depending on users' academic marks and/or attendance records. For example, users with high marks may accumulate money designated for charitable donation at a faster rate e.g. 40 cents or 50 cents per viewed ad as opposed to 25 cents. Users may have four causes represented for their donations: their school, a major charity partner and two of their own causes which they can change at any time. Students may support a third (or more) “personal” cause(s) in their list of represented causes if they, for example, demonstrate improvement or become an “ambassador” for the system and bring in or generate a certain value of sponsor or advertisement revenue. The more times a given organization or program (which must have a profile page within the site) gets selected by a user as the user's chosen cause, the higher their ranking and positioning among the list of recommended organizations/programs that relate to the advertisement being viewed.

In one embodiment, the ranking of the organization or program is partially dependent on how often users select the organisation as a chosen cause, and how much the organisation has indicated that it wishes to be emphasized in a given geographical region or aligned with a given advertisement. This list may appear at the end of each advertisement (with applicable organizations for that ad in the list) along with the sponsor of that advertisement. The user may reorder the list according to relevant criteria, such as popularity among other users, geographic proximity to the user, or relevance to the user's profile.

One feature of the invention may allow users to collaborate on joint ventures such as school projects. The system's software may create a virtual whiteboard where students can collaborate on a wide range of projects. Teachers may post notices on virtual bulletins or post and archive recorded lessons. The system's collaborative software may have email and online chat capabilities with teachers or other colleagues or outside third parties. The system will allow at least some part of a user's information to be visible to some users and may be customized for other viewers.

Another feature of the invention will allow users to view or post videos or pictures which may have broadcast capabilities for advertisements, tutoring students on any subject or for any other reason to disseminate information.

Social needs among a particular user may increase or decrease over time. In a preferred embodiment, the system may also be used to track and compare the progress of individual users over time as future surveys may be conducted to yield comparative data. Future surveys may be compared to the original surveys to note what changes or improvements may have occurred with the primary user.

In one embodiment, the system will allow users to rate their teachers and thereby yield ranking results for teachers. The results may be publicly viewable on the system, or available only to school administration.

1. A method for delivering content to users over a computerized system based on an evaluation of sensitivity to social issues, comprising:
(a) collecting information from a user, the information including at least one primary data point that indicates the user's sensitivity to at least one social issue;
(b) evaluating the user's sensitivity to the at least one social issue on the basis of the at least one primary data point;
(c) selecting issue-specific content to be displayed to the user that is selected from a pool of content by the system based on its relevance to the user's sensitivity to the at least one social issue.

2. The method of claim 1, further comprising collecting information about a user from at least one other individual that knows the user, the information including at least one secondary data point that indicates the user's sensitivity to the at least one social issue; wherein the evaluation of the user's sensitivity to the at least one social issue is on the basis of the at least one primary data point and the at least one secondary data point.

3. The method of claim 2, wherein the at least one other individual is a parent, teacher, guardian or an individual authorized by the user, the user's parent or guardian.

4. The method of claim 1, wherein the content is displayed to the user over the Internet, and is viewable through a web-page.

5. The method of claim 1, wherein the content comprises contact information or links to resources that pertain to the at least one social issue.

6. The method of claim 1, wherein the content comprises text, an image or video that pertains to the at least one social issue.

7. The method of claim 1, wherein the system is implemented online through the Internet.

8. The method of claim 1, wherein the collection of information from the user is conducted through an online survey comprising at least one question pertaining to the at least one social issue.

9. The method of claim 1, wherein the collection of information from the at least one other individual is conducted through an online survey comprising at least one question pertaining to the at least one social issue.

10. The method of claim 1, wherein the at least one primary data point and the at least one secondary data point are numerical values, and the step of evaluating the user's sensitivity to the at least one social issue comprises taking a weighted average of the values to derive a score or statement representing the user's sensitivity to the at least one social issue.

11. The method of claim 10, wherein the issue-specific content is selected to be displayed to the user when the score or statement matches, exceeds or falls below a predefined threshold, or falls within a predefined range, that is particular to that issue-specific content and the at least one social issue.

12. The method of claim 10, wherein the at least one social issue is selected from the group consisting of: violence, participation in gangs, oppression, bullying, obesity and other health risks, substance abuse, theft, street racing, suicide, divorce or separation of parents or guardians, domestic abuse, and truancy.

13. The method of claim 10, wherein the at least one social issue is discrimination on the basis of race, creed, skin colour, ethnicity, sexual orientation, gender, age, disability/ability, religion, or heritage.

14. The method of claim 10, wherein the at least one social issue is selected from the group consisting of: sexual activity, abstinence, teen pregnancy, sexually transmitted infections, sexual assault, and abortion.

15. The method of claim 1, wherein the information collected from the user includes information regarding availability for employment, age and geographical location, further comprising selecting for display job opportunities or volunteer positions selected from a pool of job opportunities or volunteer positions based on the user's availability and suitability for employment and the user's age.

16. The method of claim 15, wherein information collected from the user includes a résumé and the selection for display of job opportunities or volunteer positions is based on at least a part of the user's résumé.

17. The method of claim 15, wherein information collected from the user includes an indication of the user's performance in an educational environment, and/or their attendance records.

18. The method of claim 15, further comprising accepting from a user an application to apply for one of the selected job opportunities or volunteer positions, and forwarding the application to a prospective employer or volunteer agency.

19. The method of claim 1, wherein the information collected from the user includes information regarding the user's age, gender and geographical location, further comprising selecting for display advertisements selected from a pool of advertisements based on the user's age, gender and geographical location.

20. The method of claim 19, wherein, for each advertisement that the user watches in its entirety, the user is allocated credit representing a currency which is to be paid at least in part to a charity, community-based or non-profit organisation.

21. The method of claim 20, wherein the charity, community-based or non-profit organisation is one that is selected by the user.

22. The method of claim 1, wherein at least a part of the information is displayed in at least one profile that is visible to other users.

23. The method of claim 22, wherein at least a part of the information is displayed in two or more profiles.

24. The method of claim 1, wherein at least a portion of the information is imported from a third party system that contains personal information of the user.

25. The method of claim 1, wherein a portion of the information is integrated into the content that is delivered to the user.

26. A system for delivering content to users based on an evaluation of sensitivity to social issues that performs the steps of claim 1.

27. The system of claim 26 wherein the system acts as a server, collects information from a user through a client, and delivers content to be displayed to a user through the client.

28. The system of claim 26 further comprising at least one display mounted within a building to be seen by more than one user, wherein the system selects issue-specific content to be displayed within the building and displays the issue-specific content on the at least one display.

29. The system of claim 28 wherein the issue-specific content is selected based on its relevance to the majority of the more than one user's sensitivity to the at least one social issue.

30. The system of claim 26 further comprising a messaging module which permits users to communicate with each other through the system.

31. The system of claim 30 wherein the messaging module comprises an email system and/or a SMS system to permit users to communicate with third parties that are not part of the system using email and/or SMS through the system.

32. The system of claim 31, wherein the messaging module receives a message from a user and releases a portion of the information to a third party.

33. The system of claim 26 further comprising a compatibility module which evaluates a degree of compatibility between criteria that the user has pre-selected and designated as desirable in his or her profile preferences, and a second user's information, and displays to the user the degree of compatibility with the second user upon request by the user.

34. The system of claim 33, wherein the compatibility module evaluates a first degree of compatibility of the user in respect of the second user, and a second degree of compatibility of the second user in respect of the user, and the compatibility module compares the first degree of compatibility to the second degree of compatibility, and if both degrees of compatibility are high the compatibility module returns with an indication that each user is a potentially good match for the other.

35. The system of claim 26 further comprising a messaging system which permits users to communicate with each other through the system.

36. A memory having recorded thereon statements and instructions for execution by a computer to carry out the method of claim 1.

37. A method comprising transmitting over a communications medium computer-executable instructions for causing a computer system programmed thereby to perform the method of claim 1.

38. A method comprising storing on a memory computer-executable instructions for causing a computer system programmed thereby to perform the method of claim 1.
